(19) United States
(12) Patent Application Publication
(10) Pub. No.: US 2012/0230055 A1
(43) Pub. Date: Sep. 13, 2012

(54) FRONT LIGHT ILLUMINATION DEVICE AND REFLECTIVE DISPLAY DEVICE EMPLOYING THE SAME

(75) Inventors: HSIEN-LUNG HO, Tu-Cheng (TW); CHIU-HSIUNG LIN, Tu-Cheng (TW); KUAN-JUI HUANG, Tu-Cheng (TW)

(73) Assignee: HON HAI PRECISION INDUSTRY CO., LTD., Tu-Cheng (TW)

(21) Appl. No.: 13/270,239

(22) Filed: Oct. 11, 2011

(30) Foreign Application Priority Data
Mar. 11, 2011 (TW) 100108253

(51) Int. Cl. F21V 8/00

(52) U.S. Cl. 362/609

(57) ABSTRACT

A display device includes a display layer and a light guide plate (LGP) arranged on the display layer. The LGP includes a first surface facing away from the display layer, an opposite second surface, and a lateral surface between the first and second surfaces, the lateral surface having a light incident portion. A light source and a scanning mirror are arranged on the lateral surface of the LGP. The light source configured to emit a light beam toward the scanning mirror, the scanning mirror being reciprocally rotatable about a rotating axis at a given frequency, the scanning mirror configured to reflect and direct the light beam from the light source to enter into the LGP through the light incident portion.

### BACKGROUND

1. Technical Field

The present disclosure relates to a front light illumination device, especially to a reflective display device employing the same.

2. Description of Related Art

Nowadays, reflective displays, such as electronic paper (E-paper) displays are adopted by some types of electronic devices such as electronic book readers. The E-paper display does not include a back light and illuminates the display by reflecting ambient light. When the ambient light is weak, the illumination of the E-paper display is non-existent or very low.

Therefore, what is needed is a reflective display device with a front illumination device alleviating the limitations described above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a cross-sectional view showing a reflective display device with a front illumination unit in accordance with a first exemplary embodiment.

FIG. 2 is a schematic, isometric view showing the front illumination unit of the reflective display device of FIG. 1.

FIG. 3 is an isometric view showing a light guide plate (LGP) of the reflective display device of FIG. 1.

FIG. 4 is a cross-sectional view showing the light paths of the front illumination unit of the reflective display device of FIG. 1.

FIG. 5 is a block diagram of the reflective display device with a front illumination unit in accordance with the first exemplary embodiment.

FIG. 6 is an isometric view showing a front illumination unit of a reflective display device in accordance with a second exemplary embodiment.

FIG. 7 is an isometric view showing a front illumination unit of a reflective display device in accordance with a third exemplary embodiment.

### DETAILED DESCRIPTION

The disclosure, including the accompanying, is illustrated by way of example and not by way of limitation. It should be noted that references to “an” or “one” embodiment in this disclosure are not necessarily to the same embodiment, and such references mean at least one.

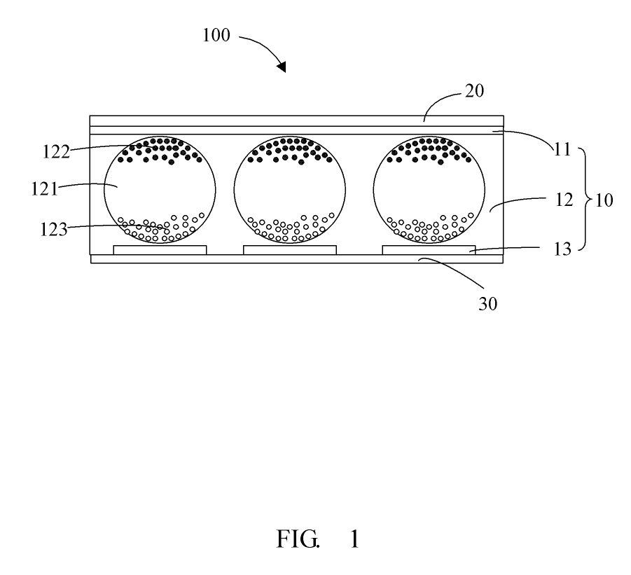

Referring to FIG. 1, a first embodiment of a reflective display device 100 is illustrated. The reflective display device 100 includes a display layer 10, a light guide plate (LGP) 20, a substrate 30, and a power unit (not shown). The display layer 10 is arranged between the LGP 10 and the substrate 30. In the first embodiment, the display layer 10 is based on electronic paper (E-paper), and includes a common electrode 11, an electrophoretic medium layer 12, and a pixel electrode 13.

The common electrode 11 is located between the LGP 20 and the electrophoretic medium layer 12, which corresponds to the display area of the LGP 20. The common electrode 11 can be made of indium tin oxide (ITO). The pixel electrode 13 is located between the substrate 30 and the electrophoretic medium layer 12. The pixel electrode 13 includes a number of thin film transistor (TFT) electrodes.

The electrophoretic medium layer 12 is a bistable electrophoretic display medium, and in the first embodiment, the electrophoretic medium layer 12 can be an encapsulated electrophoretic medium. The electrophoretic medium layer 12 includes a number of microcapsules 121, each of which comprises a capsule wall containing suspension fluid in which a number of first charged particles 122 and a number of second charged particles 123 are suspended. The first charged particles 122 and the second charged particles 123 are provided with different optical and electrical properties. Upon the application of an electrical field between the common electrode 11 and the pixel electrode 13, either the first charged particles 122 or the second charged particles 123 move to the common electrode 11 and the very small-scale presence or absence of the particles 122 and 123 at the electrode 11 layer forms images on the display device 100.

The LGP 20 is transparent and may be made of plastic or glass, such as polymethyl methacrylate (PMMA).

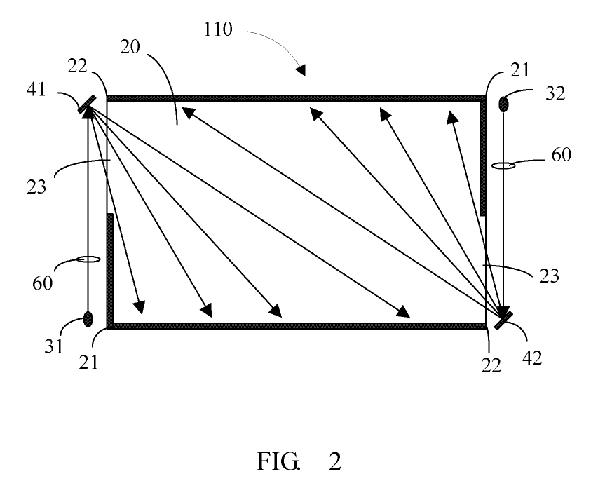

Referring to FIG. 2, a front illumination unit 110 of the reflective display device 100 is illustrated. In the first embodiment, the LGP 10 is rectangular, and two light sources 31, 32 are respectively arranged on the first diagonal corners of the LGP 10. Two scanning mirrors 41, 42 are respectively arranged on the other, second diagonal corners of the LGP 10. The light sources 31, 32 can be white LEDs or RGB mixed LEDs, and the scanning mirrors 41,42 are reciprocally rotatable about a rotating axis at a given frequency. In this embodiment, the scanning mirrors 41,42 are biaxial Micro-Electro-Mechanical System (MEMS) scanning mirrors that have three dimensional scanning ability, and can scan and reflect light beams.

The light beams being emitted from the light source 31 travel to the scanning mirror 41, and are reflected by the scanning mirror 41. The reflected light beams travel in different directions (in three dimensions) because of the tilting of the reflection plane of the scanning mirror 41. After being reflected by the scanning mirror 41, the reflected light beams then enter the LGP 20 from the incidence portion 23 defined on the lateral surface of the LGP 20. In a similar way, the light beams being emitted from the light source 32 are scanned and reflected by the scanning mirror 42, the reflected light beams enter the LGP 20 from the incidence portion 23.

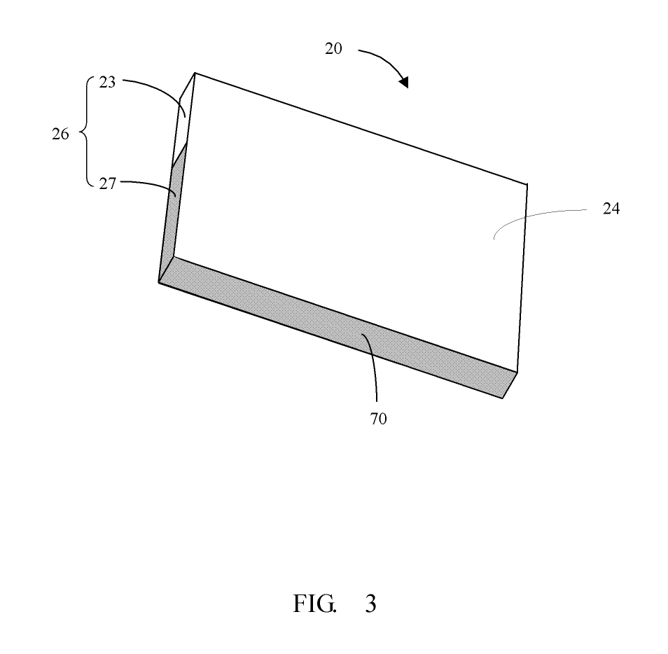

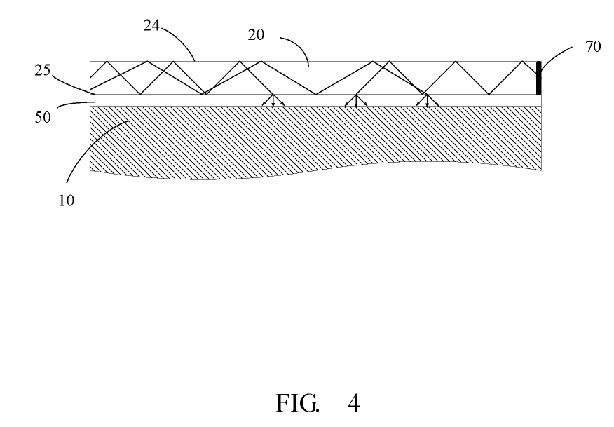

Referring to FIGS. 3 and 4, the LGP 20 includes a first surface 24, an opposing, second surface 25 and a lateral surface 26 between the first and second surfaces. The lateral surface 26 of the LGP 20 consists of a light incident portion 23 and a light reflecting portion 27, and a reflecting film 70 is formed over the light reflecting portion 27 of the lateral surface 26. The light beams reaching the high reflectance film 70 will be reflected back, and not scattered or lost. The high reflectance film 70 can be a metal reflection coating chosen from the group consisting of an aluminum coating, a gold coating and a silver coating arranged on the sidewall of the LGP 20.

Referring to FIG. 4, the front illumination unit 110 further includes a diffuser plate 50 arranged between the second surface 25 and the display layer 10. The diffuser plate 50 is configured for scattering the light beans which enter it. The light beams reflected by the scanning mirror 41,42 enter the LGP 20 from different directions. Some of the light beams reaching the first surface 24 are refracted and escape outside, while some of the light beams are internally reflected and continue to be reflected multiple times between the first surface 24 and the second surface 25. Some of the light beams reaching the second surface 25 are refracted and enter the diffuser plate 50, and then reach the display layer 10, while some of the light beams are internally reflected multiple times between the first surface 24 and the second surface 25 before ultimately reaching the display layer 10. As a result, the output of light to the display layer 10 is largely homogeneous, which contributes to a comfortable viewing of the content on the display layer 10. When the ambient light is weak or there is no ambient light, the light source 31, 32 can be electrically powered to provide illumination for the display layer 10.

Referring again to FIG. 2, a converging lens 60 may be arranged between the light source 31 and the scanning mirror 41, to focus the light beams being emitted from the light source 31. Similarly, a converging lens 60 may be arranged between the light source 32 and the scanning mirror 42. In other embodiments, the light source can be a laser light source, and in this case, the converging lens 60 can be omitted because the light emitted by a laser is coherent and focused.

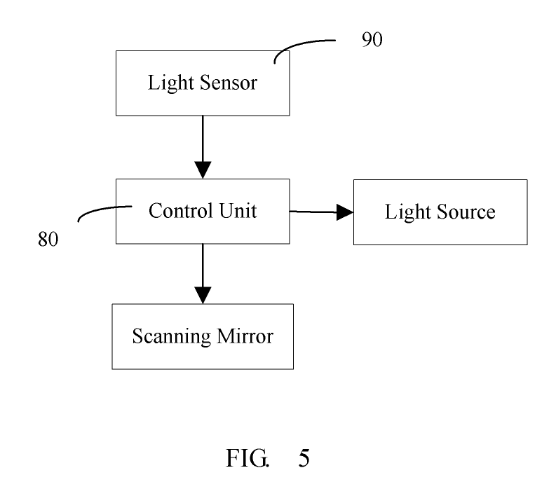

Referring to FIG. 5, the reflective display device 100 further includes a control unit 80 and a light sensor 90. The light sensor 90 is used to detect the ambient light. When the ambient light level detected by the light sensor 90 is less than a predetermined value within a predetermined time period, the light sensor 90 sends a signal to the control unit 80 to switch on the light sources 31, 32.

In another embodiment, the light sources 31, 32 and the scanning mirrors 41, 42 are arranged on the lateral sides of the LGP 20. The number of the light sources can be more than two, and there is an equal number of the scanning mirrors.

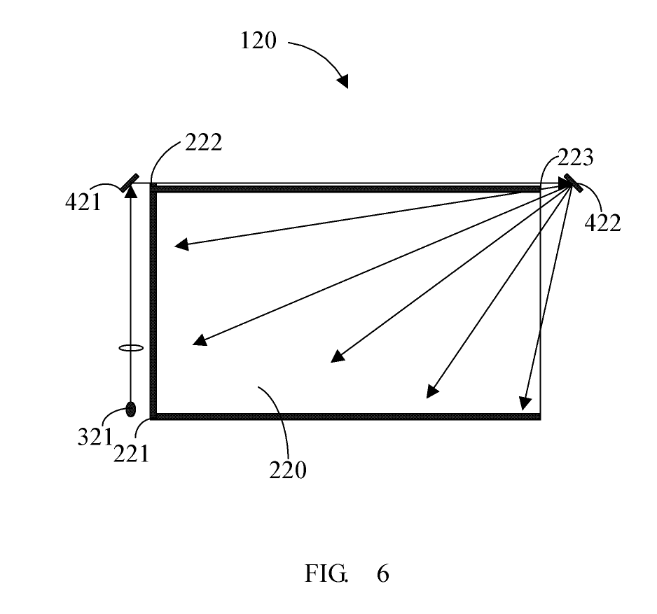

Referring to FIG. 6, a front illumination unit 120 of a reflective display device (not shown) according to a second embodiment is illustrated. The front illumination unit 120 is similar to the front illumination unit 110 described above. The front illumination unit 120 includes an LGP 220 including a first corner 221, a second corner 222 adjacent to the first corner 221 and a third corner 223 diagonal to the first corner 221. The difference between the front illumination units 120 and 110 is that a light source 321 is arranged on the first corner 221 of the LGP 220, and a first scanning mirror 421 is arranged on the second corner 222 and a second scanning mirror 422 is arranged on the third corner 223. In the second embodiment, the first scanning mirror 421 and the second scanning mirror 422 are uniaxial MEMS scanning mirrors that have a two-dimensional scanning ability, and can scan and reflect light beams.

The light beams emitting from the light source 321 travel to the first scanning mirror 421, and are reflected by the first scanning mirror 421. The reflected light beams travel in different directions (in two dimensions) because of the tilting of the reflection plane of the first scanning mirror 421. The reflected light beams are further reflected by the second scanning mirror 42 and travel in different directions (in three dimensions). Finally, the light beams enter the LGP 220 from the incidence portion (not labeled) which is defined on the lateral surface of the LGP 220.

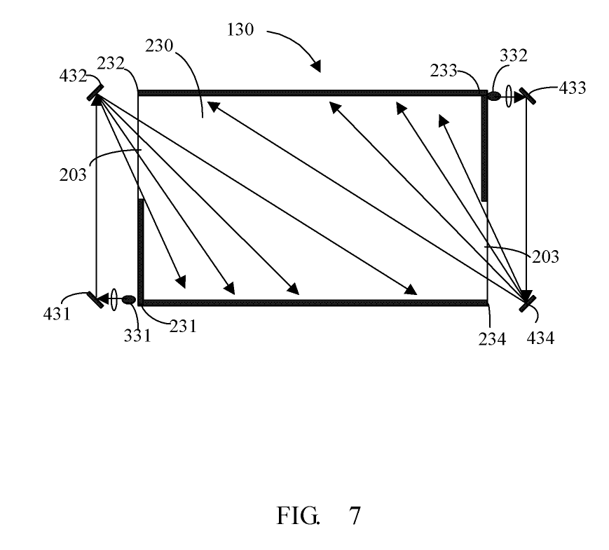

Referring to FIG. 7, a front illumination unit 130 of a reflective display device (not shown) according to a third embodiment is illustrated. The front illumination unit 130 is similar to the front illumination unit 120 described above in the second embodiment. The front illumination unit 130 includes an LGP 230 including a first corner 231, a second corner 232 adjacent to the first corner 231, a third corner 233 diagonal to the first corner 231 and a fourth corner diagonal to the second corner 232. The difference between the front illumination units 130 and 120 is that a light source 331 and a first scanning mirror 431 are arranged on the first corner 231 of the LGP 230, and a light source 332 and a first scanning mirror 433 are arranged on the first corner 233 of the LGP 230. A second scanning mirror 432 is arranged on the second corner 232 and a second scanning mirror 434 is arranged on the fourth corner 234.

In this embodiment, the first scanning mirror 431, 433 and the second scanning mirror 432,434 are uniaxial MEMS scanning mirrors. The rotating axis of the first scanning mirror 431 is perpendicular to the rotating axis of the second scanning mirror 432, and the rotating axis of the first scanning mirror 433 is perpendicular to the rotating axis of the second scanning mirror 434.

The light beams which are emitted from the light source 331 travel to the first scanning mirror 431, and are reflected by the first scanning mirror 431. The reflected light beams travel in different directions (in two dimensions) because of the tilting of the reflection plane of the first scanning mirror 431. The reflected light beams are further reflected by the second scanning mirror 432 and travel in different directions (in three dimensions). Finally, the light beams enter the LGP 230 from the incidence portion (not labeled) which is defined on the lateral surface of the LGP 230. Similarly, the light beams being emitted from the light source 332 are scanned and reflected twice, by the first scanning mirror 433 and by the second scanning mirror 434, the reflected light beams travel in different directions (in three dimensions) and enter the LGP 230.

In other embodiments, the front illumination units 110, 120 and 130 are not limited to being arranged on the front plane of the reflective display device. The front illumination units 110, 120 and 130 or any of them can be utilized independently from the other two, such as utilization as an illumination device for providing front light for books or poster boards.

If any of the front illumination units 110, 120 and 130 is independently used as a front light illumination device, the light beams reflected by the scanning mirror travel in different directions, and enter the LGP from the lateral surface. Then some of the light beams reaching the first surface and the second surface are refracted and escape outside, while some of the light beams are internally reflected multiple times between the first surface and the second surface before ultimately escaping outside through being refracted from the first surface and the second surface.

It is to be understood, however, that even though numerous characteristics and advantages of the present disclosure have been set forth in the foregoing description, together with details of the structure and function of the present disclosure, the present disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A reflective display device comprising:
a display layer;
a light guide plate (LGP) arranged on the display layer, the LGP comprising a first surface facing away from the display layer, an opposite second surface, and a lateral surface between the first and second surfaces, the lateral surface having a light incident portion;
a light source arranged on the lateral surface of the LGP, and
a scanning mirror arranged on the lateral surface of the LGP, the light source configured to emit a light beam toward the scanning mirror, the scanning mirror being reciprocally rotatable about a rotating axis at a given frequency, the scanning mirror configured to reflect and direct the light beam from the light source to enter into the LGP through the light incident portion.

2. The reflective display device of claim 1, wherein the scanning mirror is a micro-electro-mechanical system (MEMS) scanning mirror.

3. The reflective display device of claim 2, wherein the scanning mirror is a bi-axial MEMS scanning mirror.

4. The reflective display device of claim 2, wherein the at least one scanning mirror is a uniaxial MEMS scanning mirror.

5. The reflective display device of claim 1, wherein the lateral surface of the LGP consists of the light incident portion and a light reflecting portion, and a reflecting film is formed over the light reflecting portion of the lateral surface.

6. The reflective display device of claim 5, wherein the reflecting film is a metal reflecting coating chosen from the group consisting of an aluminum coating, a gold coating and a silver coating.

7. The reflective display device of claim 1, wherein the light source is an LED or a laser light source.

8. The reflective display device of claim 1, wherein a converging lens is arranged between the light source and the scanning mirror.

9. The reflective display device of claim 1, wherein a diffuser plate is arranged between the second surface and the display layer.

10. A front illumination device comprising:
an LGP comprising a first surface, an opposite second surface, and a lateral surface between the first and second surfaces, the lateral surface having a light incident portion;
a light source arranged on the lateral surface of the LGP, and a scanning mirror arranged on the lateral surface of the LGP, the light source configured to emit a light beam toward the scanning mirror, the scanning mirror being reciprocally rotatable about a rotating axis at a given frequency, the scanning mirror configured to reflect and direct the light beam from the light source to enter into the LGP through the light incident portion.

11. The front illumination device of claim 10, wherein the scanning mirror is a micro-electro-mechanical systems (MEMS) scanning mirrors.

12. The front illumination device of claim 11, wherein the scanning mirror is a biaxial MEMS scanning mirror.

13. The front illumination device of claim 11, wherein the at least one scanning mirror is a uniaxial MEMS scanning mirror.

14. The front illumination device of claim 10, wherein the lateral surface of the LGP consists of the light incident portion and a light reflecting portion, and a reflecting film is formed over the light reflecting portion of the lateral surface.

15. The front illumination device of claim 10, wherein the reflecting film is a metal reflecting coating chosen from the group consisting of an aluminum coating, a gold coating and a silver coating.

16. The front illumination device of claim 10, wherein the light source is an LED or a laser light source.

17. The front illumination device of claim 10, wherein a converging lens is arranged between the light source and the scanning mirror.
